(19) United States
(12) Patent Application Publication
(10) Pub. No.: US 2022/0319156 A1
(43) Pub. Date: Oct. 6, 2022

(54) APPROACH TO UNSUPERVISED DATA LABELING

(71) Applicant: NEC Laboratories America, Inc., Princeton, NJ (US)

(72) Inventors: Alexandru Niculescu-Mizil, Plainsboro, NJ (US); Eric Cosatto, Red Bank, NJ (US)

(21) Appl. No.: 17/711,667

(22) Filed: Apr. 1, 2022

Related U.S. Application Data
(60) Provisional application No. 63/170,656, filed on Apr. 5, 2021.

(51) Int. Cl. G06V 10/774; G06V 10/778; G06V 10/82

(52) U.S. Cl. CPC G06V 10/7747; G06V 10/7788; G06V 10/82

(57) ABSTRACT

Systems and methods for labelling data is provided. The method includes receiving data at a detector, and identifying a set of objects and features in the data using a neural network. The method further includes annotating the data based on the identified set of objects and features, and receiving a query from a user. The method further includes transforming the query into a representation that can be processed by a symbolic engine, and receiving the annotated data and a transformed query at the symbolic engine. The method further includes matching the transformed query with the annotated data, and presenting the annotated data that matches the transformed query to the user in a labelling interface. The method further includes applying new labels received from the user for the annotated data that matches the transformed query, recursively utilizing the newly annotated data to refine the detector.

### RELATED APPLICATION INFORMATION

This application claims priority to U.S. Provisional Patent Application No. 63/170,656, filed on Apr. 5, 2021, incorporated herein by reference in its entirety.

### BACKGROUND

### Technical Field

The present invention relates to systems and methods of data labeling, and more particularly to use of descriptive language and logical reasoning in an automated labeling process.

### Description of the Related Art

Labeled data is used for today's machine learning and machine vision models. Actually labeling the data, however, is a complex and expensive task. Data labeling is especially hard if the categories that need to be labeled are complex or rare. People performing labelling would need to look at a large number of data instances (e.g. images or videos) in order to find enough instances that contain the category of interest.

### SUMMARY

According to an aspect of the present invention, a method is provided for labelling data. The method includes receiving data at a detector, and identifying a set of objects and features in the data using a neural network. The method further includes annotating the data based on the identified set of objects and features, and receiving a query from a user. The method further includes transforming the query into a representation that can be processed by a symbolic engine, and receiving the annotated data and a transformed query at the symbolic engine. The method further includes matching the transformed query with the annotated data, and presenting the annotated data that matches the transformed query to the user in a labelling interface. The method further includes applying new labels received from the user for the annotated data that matches the transformed query, and recursively utilizing the newly annotated data to refine the detector.

According to another aspect of the present invention, a computer system is provided for labelling data. The computer system includes one or more processors, a computer memory; and a display screen in electronic communication with the computer memory and the one or more processors. The computer memory includes a detector configured to identify a set of objects and features in the data using a neural network; a query processor configured to transform a query from a user into a representation that can be processed by a symbolic engine; a symbolic engine configured to receive the annotated data and the transformed query, and match the transformed query with the annotated data; and a labelling interface configured to present the annotated data matching the transformed query to the user on the display screen, and receive new labels from the user to update the annotated data, wherein the updated annotated data is used for recursively refining the detector.

According to an aspect of the present invention, a non-transitory computer readable storage medium comprising a computer readable program for a computer implemented labelling system is provided for labelling data. The computer readable program when executed on a computer causes the computer to perform the steps of receiving data at a detector, and identifying a set of objects and features in the data using a neural network. The computer readable program when executed on a computer further causes the computer to perform the steps of annotating the data based on the identified set of objects and features, and receiving a query from a user. The computer readable program when executed on a computer further causes the computer to perform the steps of transforming the query into a representation that can be processed by a symbolic engine, and receiving the annotated data and a transformed query at the symbolic engine. The computer readable program when executed on a computer further causes the computer to perform the steps of matching the transformed query with the annotated data, and presenting the annotated data that matches the transformed query to the user in a labelling interface. The computer readable program when executed on a computer further causes the computer to perform the steps of applying new labels received from the user for the annotated data that matches the transformed query, and recursively utilizing the newly annotated data to refine the detector.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating a high-level system/method for labeling data using trained machine learning models that can detect basic categories, in accordance with an embodiment of the present invention;

FIG. 2 is a block/flow diagram illustrating examples of labeling data using trained machine learning models that can detect basic categories, in accordance with an embodiment of the present invention;

FIG. 3 is a block diagram illustrating a labelling system for labelling data, in accordance with an embodiment of the present invention; and

FIG. 4 is an illustration of a user interacting with the system to refine a detector model, in accordance with an embodiment of the present invention.

### DETAILED DESCRIPTION OF PREFERRED EMBODIMENTS

In accordance with embodiments of the present invention, systems and methods are provided to/for data labelling. Labeled data is used for machine learning and machine vision models. Labeling data, however, is a complex and expensive task. Data labeling is especially hard if the categories that need to be labeled are complex or rare. Labelers would need to look at a large number of data instances (e.g. images or videos) in order to find enough instances that contain the category of interest.

In one embodiment, a labelling system can ease the burden of data labeling, where a user can describe one or more categories of interest in terms of features and attributes that the labelling system already understands.

It is to be understood that aspects of the present invention will be described in terms of a given illustrative architecture; however, other architectures, structures, materials and process features and steps can be varied within the scope of aspects of the present invention.

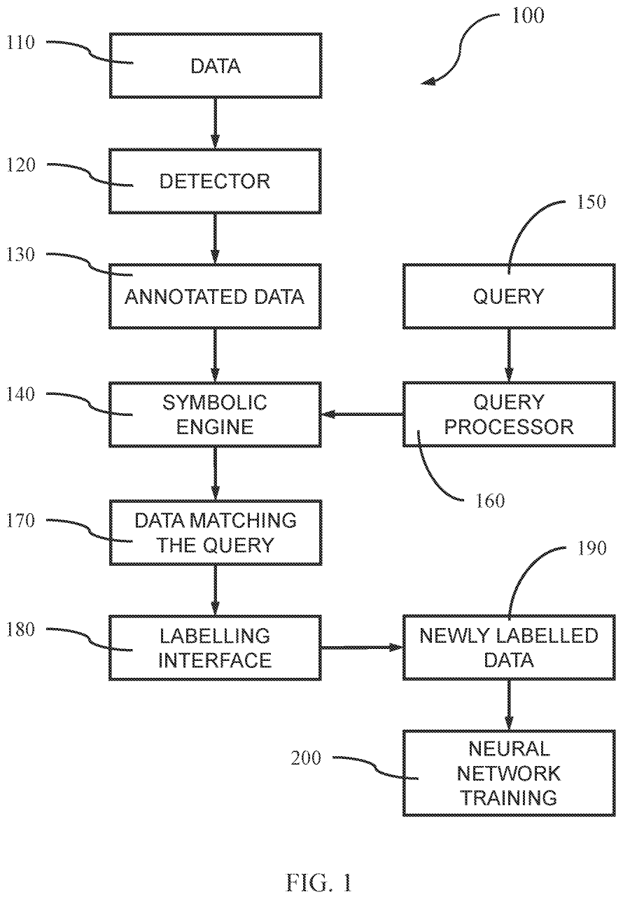

Referring now in detail to the figures in which like numerals represent the same or similar elements and initially to FIG. 1 is a block/flow diagram illustrating a high-level system/method for labeling data using trained machine learning models that can detect basic categories, in accordance with an embodiment of the present invention.

In one or more embodiments, data 110 can be inputted to a detector 120 that can attach annotations to the inputted data instances and output annotated data 130. In various embodiments, the data can be stored in a data repository that include a collection of files of a data type, for example, digital images, digital videos, texts, and combinations thereof. The data 110 can be stored as individual files or instances in a data base of a server or other computer system.

In one or more embodiments, the detector 120 can be a trained neural network model configured to detect/identify one or more categories of features/objects in the data 110, for example, people, animals, plants, vehicles, structures, streets, sidewalks, fire hydrants, mailboxes, traffic lights, utility poles, geographical features, etc. In various embodiments, the detector 120 can be trained to identify attributes (e.g., color, size, orientation, etc.) of the features, and/or actions of the features (e.g., sitting, standing, moving, opening, closing, etc.), and/or positional relationships of the features (e.g., in front, behind, left of, right of, above, below, etc.). The detector can be a convolutional neural network, a transformer network, or any other machine learning model.

In one or more embodiments, annotated data 130 can be generated by the detector 120. The annotated data 130 can have one or more labels associated with the particular data 110 instances input to the detector 120. The labels can identify one or more of the features detected in the data 110, where for example, a label for each feature identified in an image or video frame can be attached to the image or video frame (e.g., as metadata). In various embodiments, labels for the attributes, actions, and/or positional relationships of each identified feature can also be attached to the data 110.

In one or more embodiments, the symbolic engine 140 can receive the annotated data 130 and a transformed query from a query processor 160. In one or more embodiments, the symbolic engine 140 may be implemented using a logic language such as Prolog, or Answer Set Programming. In other embodiments the symbolic engine may be implemented using a probabilistic logic language such as Problog. The symbolic engine performs logical or probabilistic inference to assess if the transformed query 160 can be deduced from the annotated data and background knowledge. The information can be captured in logical statements. This may be accomplished by looking for a fact that matches the query. In various embodiments, the symbolic engine 140 can be a machine learning model that is trained to produce a match score between the annotated data 130 and the transformed query 160.

In various embodiments, the user can issue a query 150 in a natural language or a high-level query language to the label system 100.

The query 150 is processed by the query processor 160 and transformed into a representation that can be processed by the Symbolic Engine 140. For example, in embodiments where the Symbolic Engine 140 is implemented using the Prolog logical language, the query representation would be a Prolog query. In other embodiments where the Symbolic Engine 140 is implemented using Answer Set Programming (ASP), the query representation would consist of ASP clauses. In various embodiments the query processor 160 may be implemented using neural network models such as a transformer model, or a seq-2-seq model or other NLP techniques.

In one or more embodiments, the transformed query can be compared to the annotated data 130 and a determination made by the symbolic engine 140 regarding whether the features match the original query 150. The symbolic engine 140 can analyze each instance of annotated data 130 to determine if it matches the query 150, and output annotated data that matches the query 170. Because the number of data instances 170 of the annotated data 130 that matches the query 150 would normally contains much fewer instances than the original set of data 110, using this labelling system can significantly reduce the labeling effort and consequently the labeling cost. The query 150 can be generalized to features that the model has already been trained to recognize to identify possible instances of the features/objects to be included in the search, while allowing the user to add specific new labels for features/objects that the model has not previously trained for. The user would be able to describe the category of interest in terms of categories and attributes the system already understands (e.g. “a person in the street and not on a crosswalk” would describe jaywalking). Alternatively, the user would be able to describe instances where the category of interest is more likely to occur (e.g. one is more likely to find examples of policemen directing traffic by finding scenes with “people standing in an intersection”).

In one or more embodiments, the annotated data instances 130 that are deemed to match the query 150 by the Symbolic Engine 140 are then passed to a labeling interface 180. In various embodiments, the labeling interface 180 allows a user to annotate the data 110 with new complex feature(s) of interest. For example, if the user is interested in annotating taxi cabs in New York City, the user might collect data from traffic cameras, then issue the query “yellow car”. After the Symbolic Engine 140 returns all frames that match the query (i.e., that contain yellow cars) the user would use the labeling interface 180 to annotate the taxis in the images. This annotation is required as not all yellow cars are taxis, but the labeling effort is significantly lower as the user does not have to look at any frames that do not contain yellow cars, which are unlikely to contain the indicated taxi cabs. The labeling interface 180 can allow the user to draw a bounding box around a feature/object of interest in an image, or to select a clip (i.e., a sequence of images) that depicts an action of interest in a video. The labeling interface can be a graphical user interface (GUI) that is appropriate for the task. The GUI that allows the use to perform the annotation they desire.

In one or more embodiments, the data annotated with the new features 190 can be used to train 200 new machine learning models that identify the new concepts/features/objects of interest. These models may in turn be used as additional base detector models 120 in further iterations of labeling.

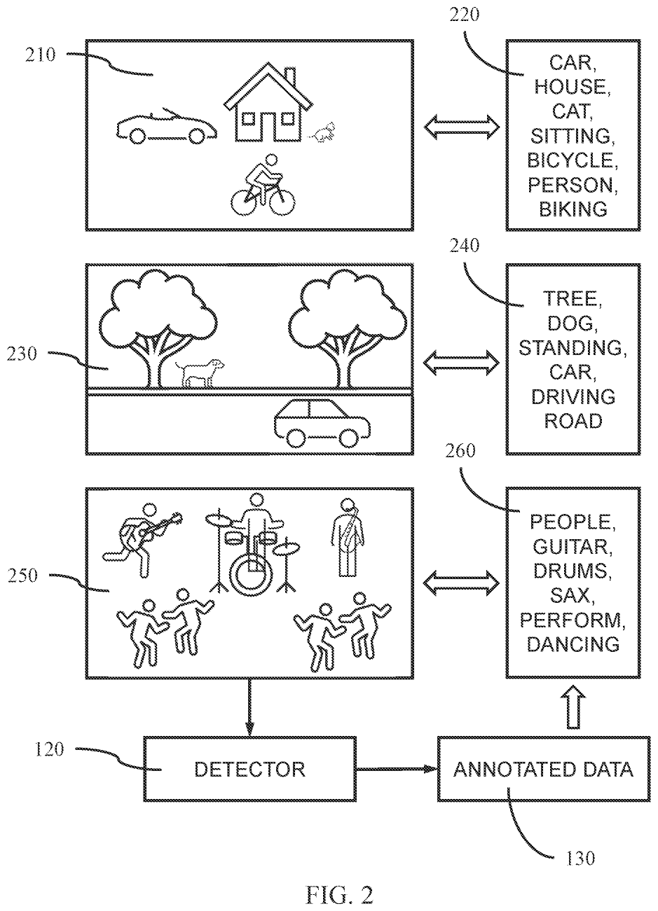

FIG. 2 is a block/flow diagram illustrating examples of labeling data using trained machine learning models that can detect basic categories, in accordance with an embodiment of the present invention.

In one or more embodiments, instances 210, 230, 250 of unlabeled data 110 can be processed by a detector 120 that can detect/identify one or more features/objects in each of the instances 210, 230, 250 of the inputted unlabeled data 110. The detection/identification of the features/objects can generate annotated data 130 by assigning a label for each detected/identified feature/object in the instance 210, 230, 250 to the particular instance 210, 230, 250. A list 220, 240, 260 of labels can be associated with each of the particular instance(s) 210, 230, 250 of the data 110 to form the annotated data 130. There can be a one-to-one mapping for each label to the identified features, or there may be a single label that identifies all features/objects in the instance, for example an image with multiple cars or prairie dogs may have only a single label of car or prairie dog associated with the instance.

In various embodiments, a natural language query 150 may be inputted by a user to identify a particular feature/object in the annotated images, that the user can then provide a refined label through a GUI labeling interface 180. The annotation(s) for the new features can be added to the list 220, 240, 260 of labels associated with the instance(s) having the new feature. The labeled data can be used to train new machine learning models that identify new concepts of interest. These models may in turn be used as additional base models in further iterations of labeling, where the newly annotated data with the refined label(s) can be utilized to recursively refine the detector. By narrowing the number of images reviewed by a user through the search query, greater labeling efficiency can be achieved.

In various embodiments, the data 110 annotated by the user with the new feature(s) 190 can be used for subsequent model training. By reducing the number of features/objects and images that would involve supervised learning and user labeling much more data can be annotated in a more efficient manner, thereby increasing the amount of labeled data for supervised learning, and reducing the costs for obtaining such labeled data.

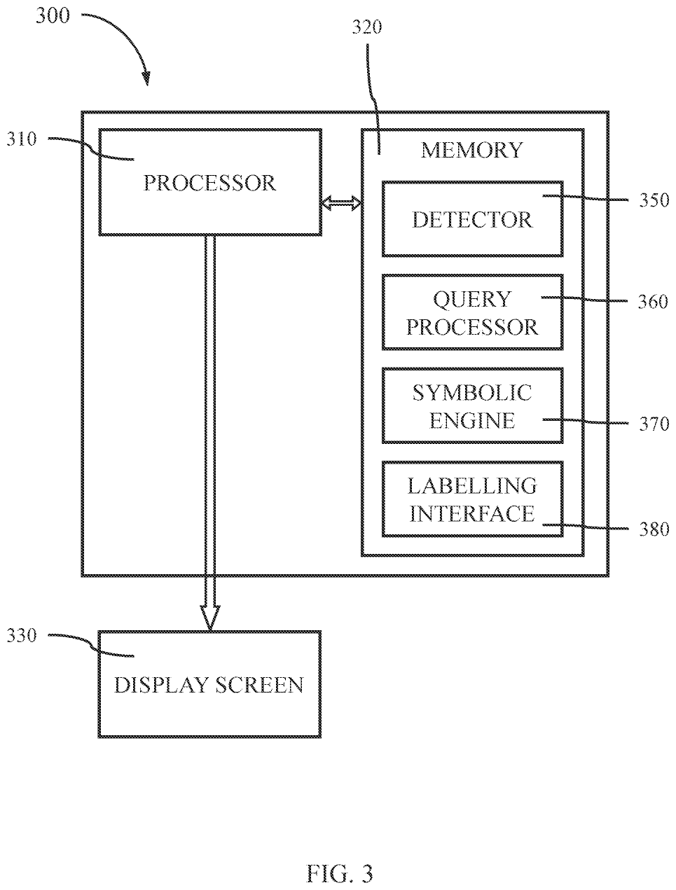

FIG. 3 is a block diagram illustrating a computer labelling system for labelling data, in accordance with an embodiment of the present invention.

In one or more embodiments, the computer labelling system 300 can include one or more processors 310, which can be central processing units (CPUs), graphics processing units (GPUs), and combinations thereof, and a computer memory 320 in electronic communication with the one or more processors 310, where the computer memory 320 can be random access memory (RAM), solid state drives (SSDs), hard disk drives (HDDs), optical disk drives (ODD), etc. The memory 320 can be configured to store the label system 100, including a detector 350, query processor 360, symbolic engine 370, and labelling interface 380. The detector 350 can be configured to identify a set of objects and features in the data using a neural network, wherein the data can include digital images and digital video. The query processor 360 can be configured to transform a query from a user into a representation that can be processed by a symbolic engine. The symbolic engine 370 can be configured to receive the annotated data and the transformed query, and match the transformed query with the annotated data, where the matching may be based on calculating a match score. The symbolic engine 370 can implement a logic language such as Prolog, Answer Set Programming, and Problog. The labelling interface 380 can be configured to present the annotated data matching the transformed query to the user on the display screen, and receive new labels from the user to update the annotated data, wherein the updated annotated data is used for the detector. The labeling interface 380 can be a graphical user interface (GUI) configured to allow the user to draw a bounding box around a feature/object in a digital image or to select a sequence of images that depicts an action of interest in a video. An updated detector can attach annotations to the received data and outputs annotated data including new labels, wherein the number of annotated data that matches the transformed query is less than the data received at the detector to reduce a labeling effort and a labeling cost. The memory 320 and one or more processors 310 can be in electronic communication with a display screen 330 over a system bus and I/O controllers, where the display screen 330 can present the annotated data, including the digital images and label lists, and configured to allow the user to draw a bounding box around a feature/object in an image or to select a sequence of images that depicts an action of interest in a video.

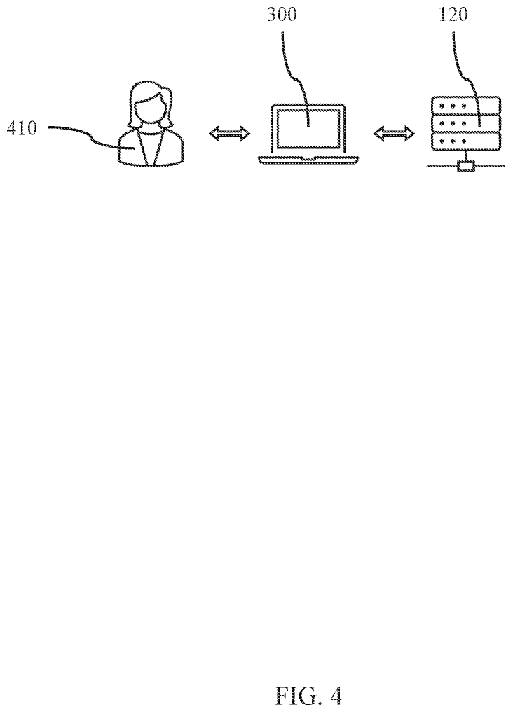

FIG. 4 is an illustration of a user interacting with the system to refine a detector model, in accordance with an embodiment of the present invention.

In one or more embodiments, a user 400 can interact with the computer labelling system 300 to update and refine the detector model(s) 120. By receiving a query 150 from a user, and identifying a subset of the data that meets the descriptors of the user query, labeling of the data can be made more efficient. Allowing the user 400 to attach new labels to the subset of data and refeeding the newly labeled data into the detector model for training can generate updated and refined detectors 120 that apply the new labels to data.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for labelling data, comprising:
receiving data at a detector;
identifying a set of objects and features in the data using a neural network;
annotating the data based on the identified set of objects and features;
receiving a query from a user;
transforming the query into a representation that can be processed by a symbolic engine;
receiving the annotated data and a transformed query at the symbolic engine;
matching the transformed query with the annotated data;
presenting the annotated data that matches the transformed query to the user in a labelling interface;
applying new labels received from the user for the annotated data that matches the transformed query; and
recursively utilizing the newly annotated data to refine the detector.

2. The method as recited in claim 1, wherein the annotated data is matched to the transformed query based on a match score calculated by the symbolic engine.

3. The method as recited in claim 2, wherein the data includes digital images and digital video.

4. The method as recited in claim 3, wherein the symbolic engine implements a logic language selected from the group consisting of Prolog, Answer Set Programming, and Problog.

5. The method as recited in claim 4, wherein the labeling interface is a graphical user interface (GUI) configured to allow the user to draw a bounding box around a feature/object in an image or to select a sequence of images that depicts an action of interest in a video.

6. The method as recited in claim 5, wherein the updated detector attaches annotations to the received data and outputs annotated data including the new labels.

7. The method as recited in claim 6, wherein the number of annotated data that matches the transformed query is less than the data received at the detector to reduce a labeling effort and a labeling cost.

8. A computer labelling system for labelling data, comprising:
one or more processors;
computer memory; and
a display screen in electronic communication with the computer memory and the one or more processors;
wherein the computer memory includes a detector configured to identify a set of objects and features in the data using a neural network;
a query processor configured to transform a query from a user into a representation that can be processed by a symbolic engine;
a symbolic engine configured to receive the annotated data and the transformed query, and match the transformed query with the annotated data; and
a labelling interface configured to present the annotated data matching the transformed query to the user on the display screen, and receive new labels from the user to update the annotated data, wherein the updated annotated data is used for recursively refining the detector.

9. The system as recited in claim 8, wherein the annotated data is matched to the transformed query based on a match score calculated by the symbolic engine.

10. The system as recited in claim 9, wherein the data includes digital images and digital video.

11. The system as recited in claim 10, wherein the symbolic engine implements a logic language selected from the group consisting of Prolog, Answer Set Programming, and Problog.

12. The system as recited in claim 11, wherein the labeling interface is a graphical user interface (GUI) configured to allow the user to draw a bounding box around a feature/object in an image or to select a sequence of images that depicts an action of interest in a video.

13. The system as recited in claim 12, wherein the updated detector attaches annotations to the received data and outputs annotated data including the new labels.

14. The system as recited in claim 13, wherein the number of annotated data that matches the transformed query is less than the data received at the detector to reduce a labeling effort and a labeling cost.

15. A non-transitory computer readable storage medium comprising a computer readable program for a computer implemented labelling system, wherein the computer readable program when executed on a computer causes the computer to perform the steps of:
receiving data at a detector;
identifying a set of objects and features in the data using a neural network;
annotating the data based on the identified set of objects and features;
receiving a query from a user;
transforming the query into a representation that can be processed by a symbolic engine;
receiving the annotated data and a transformed query at the symbolic engine;
matching the transformed query with the annotated data;
presenting the annotated data that matches the transformed query to the user in a labelling interface;
applying new labels received from the user for the annotated data that matches the transformed query; and
and recursively utilizing the newly annotated data to refine the detector.

16. The computer readable program as recited in claim 15, wherein the annotated data is matched to the transformed query based on a match score calculated by the symbolic engine.

17. The computer readable program as recited in claim 16, wherein the data includes digital images and digital video.

18. The computer readable program as recited in claim 17, wherein the symbolic engine implements a logic language selected from the group consisting of Prolog, Answer Set Programming, and Problog.

19. The computer readable program as recited in claim 18, wherein the labeling interface is a graphical user interface (GUI) configured to allow the user to draw a bounding box around a feature/object in an image or to select a sequence of images that depicts an action of interest in a video.

20. The computer readable program as recited in claim 19, wherein the updated detector attaches annotations to the received data and outputs annotated data including the new labels, and wherein the number of annotated data that matches the transformed query is less than the data received at the detector to reduce a labeling effort and a labeling cost.
